(19) United States
(12) Patent Application Publication
(10) Pub. No.: US 2023/0021716 A1
(43) Pub. Date: Jan. 26, 2023

(54) NEURAL NETWORK MODEL COMPUTING CHIP, METHOD, AND APPARATUS, DEVICE, AND MEDIUM

(71) Applicant: TENCENT TECHNOLOGY (SHENZHEN) COMPANY LIMITED, Shenzhen (CN)

(72) Inventor: Yu MENG, Shenzhen (CN)

(21) Appl. No.: 17/954,163

(22) Filed: Sep. 27, 2022

Related U.S. Application Data
(63) Continuation of application No. PCT/CN2021/106148, filed on Jul. 14, 2021.

(30) Foreign Application Priority Data
Aug. 6, 2020 (CN) 202010780693.6

(51) Int. Cl. G06N 3/08

(52) U.S. Cl. CPC G06N 3/08

(57) ABSTRACT

A method, applied to a neural network model computing chip, includes: obtaining a current instruction from a mixed instruction set including N instructions and obtained through pre-compiling based on model data of a target neural network model, the N instructions including an original instruction and control information for updating a target original instruction of the target neural network model; determining a target instruction based on the current instruction, where when the current instruction is control information, the target instruction is an update instruction obtained after the target original instruction is updated based on the control information; and parsing the target instruction, and scheduling a target engine based on a parsing result to perform a computing operation or a data migration operation indicated by the target instruction, the target engine being one of a plurality of pre-configured engines in the neural network model computing chip.

### CROSS-REFERENCES TO RELATED APPLICATIONS

This application is a continuation application of PCT Patent Application No. PCT/CN2021/106148, entitled “NEURAL NETWORK MODEL COMPUTING CHIP, METHOD AND APPARATUS, DEVICE AND MEDIUM” and filed on Jul. 14, 2021, which claims priority to Chinese Patent Application No. 2020107806936, entitled “NEURAL NETWORK MODEL COMPUTING CHIP, METHOD, AND APPARATUS, DEVICE, AND MEDIUM” and filed with the China National Intellectual Property Administration on Aug. 6, 2020, the entire contents of both of which are incorporated herein by reference.

### FIELD OF THE TECHNOLOGY

The present disclosure relates to the field of Internet technologies, specifically to the field of artificial intelligence technologies, and in particular, to a neural network model computing chip, a neural network model computing method and apparatus, a computer device, and a storage medium.

### BACKGROUND OF THE DISCLOSURE

When a neural network model is applied to a specific field, a hardware system is usually in a form of a heterogeneous network (for example, as shown in FIG. 1), which is used in cooperation with a neural network model computing chip and a general purpose processor. The neural network model computing chip focuses on acceleration of intensive computing of the neural network model, and the general purpose processor is used for completing work such as preprocessing (such as image size cropping) and post-processing (such as image information annotation) of the neural network model. This part of work is not computationally intensive, and is characterized by high flexibility requirements, which can be completed by a general purpose processor.

To deal with different neural network models, currently, neural network model computation is mainly implemented by pre-compiling a static instruction of the entire neural network model, and then driving a neural network model computing chip through the instruction. However, with the emergence of some models whose parameters need to be updated online, for example, at a decoding phase of natural language processing (NLP), some models need to identify and analyze whether a decoding result is an end of file (EOF), and then decide whether to stop. In another example, in pushback computation at a decoding phase of a transformer model, a feedback input sequence length parameter also needs to change. These changes are not available at a compilation phase, but can only be obtained after specific data is inputted into the model and computed.

### SUMMARY

Embodiments of the present disclosure provide a neural network model computing chip. The chip includes an instruction processing unit, an instruction parsing unit, a scheduling unit, and an execution unit for data migration and computation, and the execution unit includes a plurality of pre-configured engines. The instruction processing unit is configured to provide a target instruction to the instruction parsing unit, the target instruction includes at least one of an original instruction or an update instruction of a target neural network model; the update instruction is obtained after a target original instruction is updated based on control information of the target neural network model, and the target original instruction is an original instruction matching the control information in the original instruction of the target neural network model. The instruction parsing unit is configured to parse the target instruction, and input a parsing result into the scheduling unit. The scheduling unit is configured to schedule a target engine based on the parsing result to perform a target operation indicated by the target instruction, the target operation includes a computing operation or a data migration operation, and the target engine is any one of a plurality of pre-configured engines of the execution unit.

An embodiment of the present disclosure further provides a neural network model computing method, including: obtaining a current instruction from a mixed instruction set related to a target neural network model, the mixed instruction set including N instructions to be executed, the mixed instruction set being obtained through pre-compiling based on model data of the target neural network model, the N instructions including an original instruction and control information used for updating a target original instruction of the target neural network model, and N being an integer greater than 1; determining a target instruction based on the current instruction, where when the current instruction is control information, the target instruction is an update instruction obtained after the target original instruction is updated based on the control information; and parsing the target instruction to obtain a parsing result, and scheduling a target engine based on the parsing result to perform a target operation indicated by the target instruction, the target operation including a computing operation or a data migration operation, and the target engine being one of a plurality of pre-configured engines in the neural network model computing chip.

An embodiment of the present disclosure further provides a neural network model computing apparatus, including: an obtaining module, configured to obtain a current instruction from a mixed instruction set related to a target neural network model, the mixed instruction set including N instructions, the mixed instruction set being obtained through pre-compiling based on model data of the target neural network model, the N instructions including an original instruction and control information used for updating a target original instruction of the target neural network model, and N being an integer greater than 1; and a processing module, configured to determine a target instruction based on the current instruction, where when the current instruction is control information, the target instruction is an update instruction obtained after the target original instruction is updated based on the control information. The processing module is further configured to parse the target instruction, and schedule a target engine based on a parsing result to perform a target operation indicated by the target instruction, the target operation including a computing operation or a data migration operation, and the target engine being any one of a plurality of pre-configured engines in the neural network model computing chip.

Correspondingly, an embodiment of the present disclosure further provides a computer device, installed with a neural network model computing chip. The neural network model computing chip includes a processor and a storage apparatus. The storage apparatus is configured to store program instructions, and the processor is configured to invoke the program instructions and perform the neural network model computing method described above.

Correspondingly, an embodiment of the present disclosure further provides a non-transitory computer storage medium, storing program instructions, the program instructions, when executed, implementing the neural network model computing method described above.

### BRIEF DESCRIPTION OF THE DRAWINGS

FIG. 1 is a schematic structural diagram of a hardware system to which a neural network model is applied according to an embodiment of the present disclosure.

FIG. 2a is a schematic structural diagram of a neural network model computing chip according to an embodiment of the present disclosure.

FIG. 2b is a schematic structural diagram of another hardware system to which a neural network model is applied according to an embodiment of the present disclosure.

FIG. 2c is a schematic structural diagram of an instruction processing unit according to an embodiment of the present disclosure.

FIG. 3 is a schematic structural diagram of a mixed instruction set according to an embodiment of the present disclosure.

FIG. 4 is a schematic diagram of a work flow of a neural network model computing chip according to an embodiment of the present disclosure.

FIG. 5 is a schematic diagram of a work flow of an instruction processing unit according to an embodiment of the present disclosure.

FIG. 6 is a schematic flowchart of a neural network model computing method according to an embodiment of the present disclosure.

FIG. 7 is a schematic diagram of a scenario of updating instructions online according to an embodiment of the present disclosure.

FIG. 8 is a schematic structural diagram of a neural network model computing apparatus according to an embodiment of the present disclosure.

FIG. 9 is a schematic structural diagram of a computer device according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

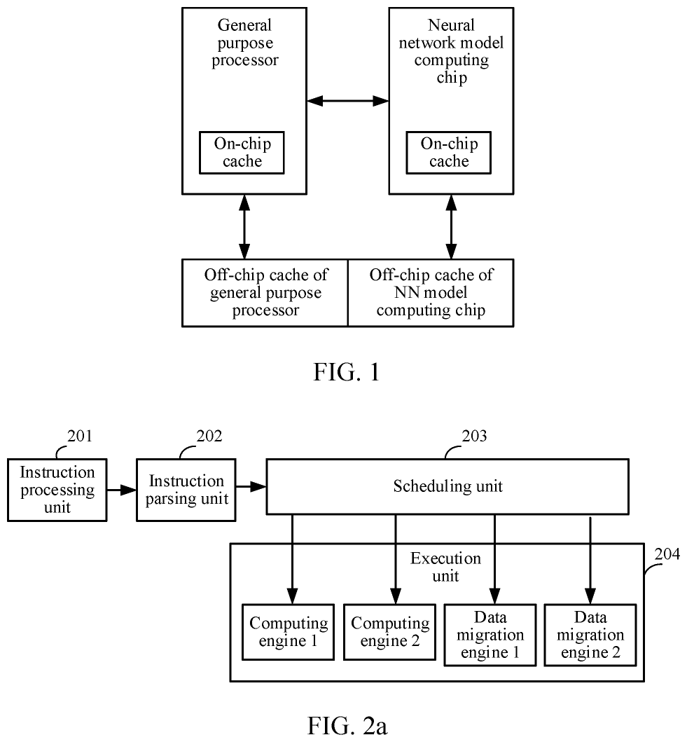

When a neural network model is applied to a specific field, a hardware system is usually in a form of a heterogeneous network (for example, as shown in FIG. 1), which is used in cooperation with a neural network model computing chip and a general purpose processor. The neural network model computing chip is used for acceleration of intensive computing of the neural network, and the general purpose processor is used for completing work before (such as image size cropping) and after (such as image information annotation) the neural network. This part of work is not computationally intensive, and is characterized by high flexibility requirements, which can be completed by a general purpose processor. The neural network model computing chip may be a chip such as a graphics processing unit (GPU), a field programmable gate array (FPGA), or an application specific integrated circuits (ASIC), and the general purpose processor may be a central processing unit (CPU).

In an existing CNN/RNN model, after the model is trained, an entire computing process is known. In intensive computing, especially common matrix computation, the entire computing process can be compiled for the neural network model computing chip, to form a complete static instruction to be fully executed by the neural network model computing chip, and during the computing process, there is no interaction between the model and the general purpose processor, so that the computing power of the neural network model computing chip can be fully exploited.

However, as model variants increase, some models whose parameters need to be updated online appear. For example, the end time of a decoding phase of NLP is not fixed, and an EOF needs to be determined to end; and in pushback computation in a transformer model, an input parameter of the next round of computation needs to be adjusted. In such a computing process, no complete computing instruction flow can be compiled to the neural network model computing chip, which needs to interact with the general purpose processor. Due to the large time delay of the interaction between the neural network model computing chip and the general purpose processor, the neural network model computing chip is easily caused to wait, and the computing power of the neural network model computing chip cannot be fully used, resulting in low computing efficiency of the neural network model.

For example, for a model whose parameters need to be updated online, in some methods, a target neural network model is split into a plurality of sub-models, and a computationally intensive part handed over to the neural network model computing chip to complete; and for a part that needs to be regenerated in the computing process, intermediate results of the sub-models are returned to the general purpose processor for recomputing, and the sub-models travel back and forth between the general purpose processor and the neural network model computing chip. From the perspective of the entire model, frequent interactions between the general purpose processor and the neural network model computing chip are required during an execution process, including an interrupt interaction for task completion, and a round-trip interaction between the computing results from the neural network model computing chip to the general purpose processor. A bus that interacts between the two usually adopts a PCIe interface. Compared with internal processing capabilities of the general purpose processor and a neural network model computing chip system, an interaction of the bus has become a bottleneck, and the frequent interactions lead to delay waiting. As a result, the computing capability of the neural network model computing chip cannot be fully exploited. This is also one of main reasons why the neural network model computing chip has high theoretical peak computing power, but some models are not ideal in actual computing power.

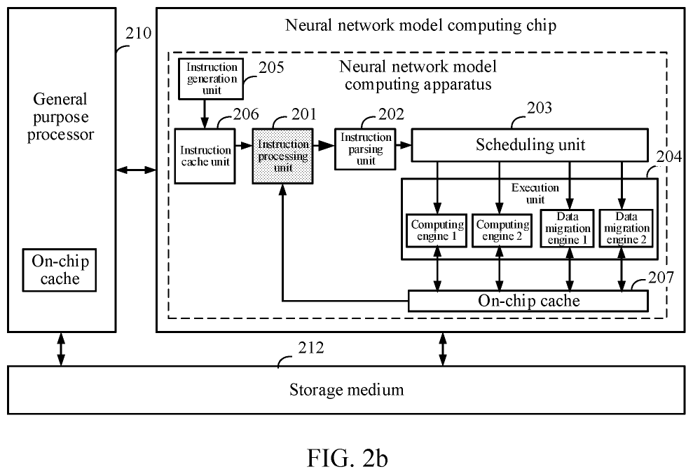

To resolve the foregoing problem, an embodiment of the present disclosure provides a neural network model computing chip. Referring to FIG. 2a, the chip includes an instruction processing unit 201, an instruction parsing unit 202, a scheduling unit 203, and an execution unit 204 for data migration and computation.

The instruction processing unit 201 is configured to provide a target instruction to the instruction parsing unit 202, the target instruction includes at least one of an original instruction or an update instruction of a target neural network model; the update instruction is obtained after a target original instruction is updated based on control information of the target neural network model, and the target original instruction is an original instruction matching the control information in the original instruction of the target neural network model. The target original instruction may also be understood as a to-be-updated original instruction indicated by the control information. The target neural network model may refer to a model (such as a CNN or an RNN) whose parameters do not need to be updated online in a computing process, or may refer to a model whose parameters need to be updated online in the computing process.

After the neural network model is trained, a corresponding model structure and parameters of each layer have been determined, and to-be-processed data (such as image data, voice data, and text data) may be inputted into the neural network, and outputted after computed. In this embodiment of the present disclosure, a trained target neural network model may be compiled into a language identifiable by the neural network model computing chip through a compiler in combination with a specific structure (for example, a supported computing unit type or a scheduling method) of the neural network model computing chip, which is an instruction generation process. For this chip, a mixed instruction set of the target neural network model may be pre-compiled. The mixed instruction set includes N (N is an integer greater than 1) to-be-executed instructions, the N to-be-executed instructions include an original instruction and control information, the control information is used for indicating the instruction processing unit 201 to obtain and execute control instructions in the control information one by one, to obtain the update instruction corresponding to the target original instruction.

In specific implementation, the instruction processing unit 201 may read the to-be-executed instructions in the mixed instruction set one by one. The original instruction may be directly used as the target instruction and directly inputted into the instruction parsing unit 202. The control instructions in the control information may be obtained and executed one by one to obtain the update instruction corresponding to the target original instruction, and the update instruction is inputted into the instruction parsing unit 202 as the target instruction, to generate a new instruction online inside the chip without interacting with other devices (such as a general purpose processor).

In this embodiment of the present disclosure, “online generation” in online generation of a new instruction is a concept relative to static compilation, and specifically refers to that a corresponding target original instruction may be updated through indication of the control information during an operational process of the neural network model, to obtain an update instruction corresponding to the target original instruction, thereby completing the “online generation” of the update instruction.

Exemplarily, it is assumed that the control information 1 includes the following indication: performing operation based on the control information according to an engine execution result of an original instruction 2, to generate a target instruction 2_1 online based on the original instruction 2. In this case, when reading the control information 1, the instruction processing unit 201 may determine the original instruction 2 as the target original instruction, obtain the engine execution result of the original instruction 2 (an intermediate computing result of the target neural network model), execute the control information 1, and generate a new instruction 2_1 online based on the original instruction 2 according to the content of the control information 1. The new instruction 2_1 is an update instruction corresponding to the original instruction 2, thereby completing the “online generation” of the new instruction 2_1.

The instruction parsing unit 202 is configured to parse the target instruction, and input a parsing result into the scheduling unit 203.

The scheduling unit 203 is configured to schedule a target engine based on the parsing result to perform a target operation indicated by the target instruction, the target operation includes a computing operation or a data migration operation, and the target engine is any one engine in the execution unit 204.

The execution unit 204 includes a plurality of pre-configured engines, and the plurality of engines may include a computing engine and a data migration engine. Specifically, for different types of computations, the computing engine may also include a plurality of types of computing engines, such as a computing engine for convolution, and a computing engine for pooling. During the target neural network model computation, corresponding data is migrated in and out. Correspondingly, the data migration engine may also include a data migration engine for migrating out data and a data migration engine for migrating in data.

In specific implementation, the scheduling unit 203 may schedule the target engine based on the parsing result for the target instruction inputted by the instruction parsing unit 202, to perform the target operation indicated by the target instruction, the target operation includes a computing operation or a data migration operation, the computing operation includes various computations, such as a convolution and a pooling, designed by the neural network, and the data migration operation includes migrating in or out data. By analogy, when the N to-be-executed instructions in the mixed instruction set are all executed, the corresponding entire target neural network model computation is completed.

Generally, the last to-be-executed instruction in the mixed instruction set is an instruction for migrating data out, and a target engine corresponding to the last to-be-executed instruction is a data migration engine for migrating data out. In this case, when the neural network model computing chip executes the last to-be-executed instruction through the target engine, the target engine may migrate a final computing result of the neural network model computing chip on the neural network to a storage medium. Subsequently, other devices (such as the general purpose processor) can obtain the final computing result of the neural network model computing chip on the target neural network model from the storage medium, and complete other required post-processing work (such as image information annotation, text information annotation, or layer processing).

It can be seen from the above that, the neural network model computing chip provided in the present disclosure has a capability of updating instructions online inside the chip, and can efficiently implement computation of the model whose parameters need to be updated online. In addition, compared with the method used for the model whose parameters need to be updated online, updating instructions online is completed internally, which can reduce interactions with other devices (such as the general purpose processor), so that the computing power of the neural network model computing chip can be fully exploited, thereby improving computing efficiency of the target neural network model.

Referring to FIG. 2b, the neural network model computing chip may further include an instruction generation unit 205, an instruction cache unit 206, and an on-chip cache 207. The chip is deployed in a hardware system, and the hardware system further includes a general purpose processor 210 and a storage medium 212.

The instruction generation unit 205 is configured to compile a mixed instruction set of the target neural network model through a compiler according to model data of the target neural network model, the mixed instruction set includes N to-be-executed instructions, and the N to-be-executed instructions include the original instruction and the control information used for updating the target original instruction. In some embodiments, the mixed instruction set may be compiled offline by the instruction generation unit 205.

It can be seen from the above that, after the neural network model is trained, a corresponding model structure and parameters of each layer have been determined, and to-be-processed data (such as image data, voice data, and text data) may be inputted into the neural network, and outputted after computed. In combination with a specific structure (for example, a supported computing unit type or a scheduling method) of the neural network model computing chip and model data of the trained target neural network model, the instruction generation unit 205 may compile a trained target neural network model into a language identifiable by the neural network model computing chip through a compiler combined with a specific structure (for example, a supported operation unit type or a scheduling method) of the neural network model operation chip and model data of the trained target neural network model, which is an instruction generation process.

The original instruction can be understood as a pre-compiled static instruction, which is obtained through compiling based on fixed model data of the trained target neural network model. This part of data can be understood as the model data that can be known in advance after the model is trained. The fixed model data may be a model structure of the target neural network model, parameters of each layer or the like. For example, convolution computation at a certain layer includes a position and a size of the on-chip cache in which input features are located, a cache position and a size corresponding to a convolution kernel, and a stride size. For a general CNN/RNN model, this part of information can be generated after the model is determined, which is used for driving the neural network model computing chip to work.

The control information is optional and is mainly used for a model whose parameters need to be updated online. For example, a decoding part of some NLP models needs to stop this round of computation when a current computing result is identified as an EOF. For CNN/RNN and other models in which computation needs to be performed while determining a subsequent model structure, the control information does not need to be included. The content included in the control information is used for indicating an instruction processing unit to obtain an intermediate computing result of the model (stored in the on-chip cache), perform some computations such as comparison determination, addition and subtraction, and comparison on the intermediate computing result, and then generate a new instruction based on the target original instruction.

A target neural network model may include M (an integer greater than 1) network layers, each network layer may correspond to one or more original instructions, and each network layer may correspond to one or more pieces of control information. In this embodiment of the present disclosure, the number of original instructions corresponding to a target neural network model is much smaller than the amount of the control information, and a ratio may generally be 9:1 or other, which is not specifically limited in the present disclosure.

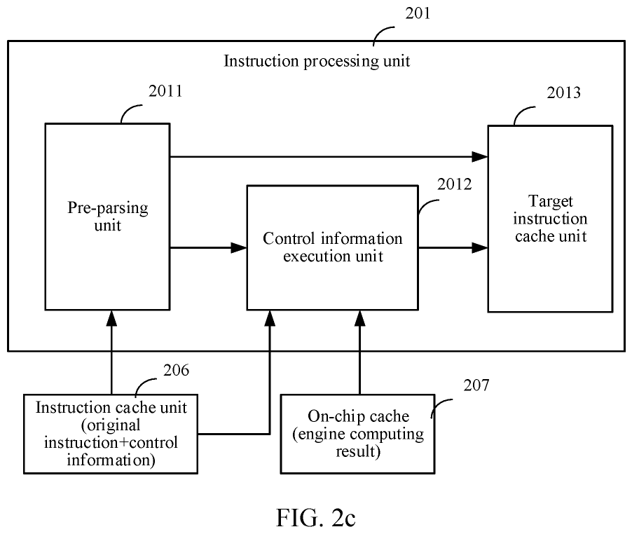

In specific implementation, in a process of generating the mixed instruction set by the instruction generation unit 205, the to-be-executed instructions in the mixed instruction set are arranged according to an order of network layers in the target neural network model. For example, if the network layers included in a certain target neural network model are as follows: a first network layer→a second network layer→a second network layer→a third network layer→a fourth network layer→a fifth network layer→a sixth network layer, the first network layer corresponds to an original instruction 1, the second network layer corresponds to an original instruction 2, the third network layer corresponds to control information 1, the fourth network layer corresponds to an original instruction 3, the fifth network layer corresponds to control information 2, and the sixth network layer corresponds to an original instruction 4. In this case, for the generated mixed instruction set, reference may be made to FIG. 3.

The instruction cache unit 206 is configured to store the mixed instruction set of the target neural network model. After the target neural network model is determined, the mixed instruction set of the target neural network model does not change, and can be loaded into the neural network model computing chip at one time, to facilitate subsequent continuous inference computation on inputted to-be-computed data (such as image data, voice data, or text data).

The instruction processing unit 201 is specifically configured to read the to-be-executed instructions in the mixed instruction set one by one. The original instruction may be directly used as the target instruction and directly inputted into the instruction parsing unit 202, and the control instructions in the control information may be obtained and executed one by one. The instruction processing unit 201 has a capability of directly accessing the on-chip cache 207, and can efficiently obtain the intermediate computing result of the target neural network model (the intermediate computing result is stored in the on-chip cache). The instruction processing unit 201 can identify and execute the control information, use the target original instruction and the intermediate computing result as an input, and perform secondary processing on the target original instruction, to obtain the update instruction corresponding to the target original instruction, so that the neural network model computing chip can generate a new instruction online internally.

Exemplarily, it is assumed that the control information 1 includes the following indication: performing operation based on the control information according to an engine execution result of an original instruction 2, to generate a target instruction 2_1 online based on the original instruction 2. In this case, when reading the control information 1, the instruction processing unit 201 may determine the original instruction 2 as the target original instruction, obtain the engine execution result of the original instruction 2 (an intermediate computing result of the target neural network model) from the on-chip cache 207, execute the control information 1, and generate a new instruction 2_1 online based on the original instruction 2 according to the content of the control information 1. The new instruction 2_1 is an update instruction corresponding to the original instruction 2.

It can be seen that the instruction processing unit 201 plays a role of online dynamic generation of an instruction, and can efficiently obtain the intermediate computing result of the model by directly reading the on-chip cache 207 according to the control information defined in the mixed instruction set, and further generate an updated instruction according to a requirement of the control information, to adapt to a parameter model that needs to be changed online. The entire process is all completed inside the neural network model computing chip.

The storage medium 212 and the on-chip cache are configured to store target data required for the target neural network model computation. The target data includes any one of the following: to-be-computed data preprocessed by the general purpose processor 210, and an intermediate computing result and a final computing result of the target neural network model computation, and the to-be-computed data includes image data, voice data, or text data. In this embodiment of the present disclosure, the intermediate computing result of the target neural network model computation may be stored through the on-chip cache 207, and the instruction processing unit 201 has a capability of directly accessing the on-chip cache 207, and can efficiently obtain the intermediate computing result of the model.

The preprocessing can be understood as preprocessing of the to-be-computed data. For example, when the to-be-computed data is an image, the processing may be cropping a size of the image. Exemplarily, generally, the first instruction in the mixed instruction set is a migration instruction for migrating in data. Before computation needs to be performed by the neural network model computing chip, the general purpose processor 210 may store preprocessed to-be-computed data into the storage medium 212 (the preprocessed to-be-computed data at this time can be regarded as the target data stored in the storage medium 212), and trigger the neural network model computing chip to work through a register or a switch. After starting to work, the neural network model computing chip may first execute the first migration instruction for migrating in data, and migrate the preprocessed to-be-computed data into the on-chip cache 207 from the storage medium 212 (the preprocessed to-be-computed data at this time can be regarded as the target data stored in the on-chip cache 207).

Further, the chip reads and executes other to-be-executed instructions in the mixed instruction set in sequence. Generally, the last to-be-executed instruction in the mixed instruction set is an instruction for migrating data out, and a target engine corresponding to the last to-be-executed instruction is a data migration engine for migrating data out. When the neural network model computing chip executes the last to-be-executed instruction, the final computing result of the target neural network model can be migrated to the storage medium (the final computing result of the target neural network model at this time can be regarded as the target data stored in the storage medium). Subsequently, the general purpose processor can obtain the final computing result of the neural network model computing chip on the target neural network model from the storage medium, and complete other required post-processing work (such as image information annotation, text information annotation, or layer processing).

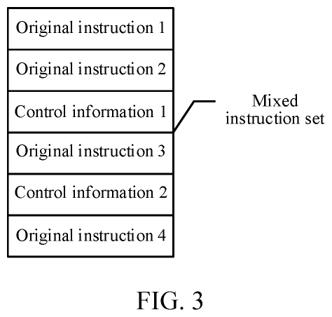

Exemplarily, for a work flow of the neural network model computing chip in FIG. 2b, reference may be made to FIG. 4, and the flow includes: S401. The instruction generation unit generates the mixed instruction set according to model data of the target neural network model. S402. Load the mixed instruction set into the instruction cache unit. In specific implementation, the mixed instruction set generated by the instruction generation unit may be loaded into the instruction cache unit. The mixed instruction set continues to act on subsequent inputs, and each input to-be-computed data is executed according to entire mixed instructions to complete an operation of the entire model.

S403. Input to-be-computed data (such as image data, voice data, or text data) continuously and complete inference computation in sequence. During computation, the control information in the mixed instruction set needs to be converted into an update instruction online. Specifically, the instruction processing unit executes the control information, updates the target original instruction to obtain the update instruction, and implements the online update of the instruction inside the chip. Further, the update instruction is inputted into the instruction parsing unit. The instruction parsing unit parses the update instruction, extracts parameter information required by a related engine and combination relationship information between the engines, and inputs the extracted information into the scheduling unit. The scheduling unit distributes the parameter information required by the engines to the engines according to the combination relationship, and the engines complete corresponding computation or data migration. After all to-be-executed instructions in the mixed instruction set are executed, corresponding entire model computation is completed, the final computing result of the target neural network model is handed over to a general purpose processor side, and the general purpose processor side completes other required post-processing work.

It can be seen that, the neural network model computing chip provided in this embodiment of the present disclosure can more efficiently resolve a problem of reduced efficiency brought about by repeated interactions of tasks and data between the general purpose processor and the neural network model computing chip when some neural network models in deep learning need to generate new instructions online, and can better adapt to the constantly evolving deep learning network. On one hand, through the “mixed instruction set” method, the original instruction can be compatible and remain unaffected, the control information is scalable, and can flexibly support various online processing needs; on the other hand, the on-chip cache can be efficiently accessed to obtain the intermediate computing result of the target neural network model by adding the instruction processing unit, avoiding time-consuming migration of the intermediate computing result to the general purpose processor; on the other hand, the execution of the control information is completed inside the neural network model computing chip, avoiding task interaction with the general purpose processor, reducing waiting time, thereby maximizing the performance of the neural network model computing chip.

Referring to FIG. 2c, the instruction processing unit 201 in FIG. 2b may specifically include: a pre-parsing unit 2011, a control information execution unit 2012, and a target instruction cache unit 2013.

The pre-parsing unit 2011 is configured to read to-be-executed instructions one by one from the mixed instruction set stored in the instruction cache unit 206, input the original instruction in the mixed instruction set into the target instruction cache unit 2013, and input the control information in the mixed instruction set into the control information execution unit 2012.

The control information execution unit 2012 is configured to update a target original instruction based on the control information to obtain an update instruction, and input the update instruction into the target instruction cache unit 2013. The control information execution unit 2012 is configured to execute the content included in the control information, update the target original instruction to obtain the update instruction, and input the update instruction into the target instruction cache unit 2013. The control information execution unit 2012 may directly access the on-chip cache 207, quickly access an intermediate computing result in the on-chip cache 207, complete required computation in combination with the control information, refresh a target original instruction in an original cache, obtain the update instruction, and finally specify a position of the update instruction in the instruction cache unit 206, and input the update instruction to the target instruction cache unit 2013 after taking out the update instruction. The control information execution unit 2012 is oriented towards an AI application, and supports the following instructions: an “operand obtaining instruction”, a “computing instruction”, an “update instruction”, and a “jump instruction”.

Exemplarily, it is assumed that the mixed instruction set related to the target neural network model includes an original instruction 1, an original instruction 2, control information 1, and an original instruction 3 in sequence. The control information 1 includes the following indication: performing operation based on the control information according to an engine execution result of the original instruction 2, to generate a target instruction 2_1 online based on the original instruction 2. In this case, the pre-parsing unit 2011 may read the to-be-executed instructions in the mixed instruction set one by one. The original instruction 1 and the original instruction 2 do not need to be updated, and are directly inputted into the target instruction cache unit 2013, and transferred to the instruction parsing unit 202 by the target instruction cache unit 2013. The instructions can be directly parsed, and then executed by driving a corresponding engine. For the control information 1, the pre-parsing unit 2011 may input the control information 1 into the control information execution unit 2012. The control information execution unit 2012 may identify and execute the control information 1, and obtain the engine execution result of the original instruction 2 (the intermediate computing result) from the on-chip cache 207, obtain the update instruction 2_1 corresponding to the original instruction 2 according to the content of the control information, and specify an address of a next instruction as a start address of the update instruction 2_1. The next instruction may be read from the update instruction 2_1, and the read update instruction 2_1 is inputted into the target instruction cache unit 2013, and transferred to the instruction parsing unit 202 by the target instruction cache unit 2013. The update instruction 2_1 can be directly parsed, and then executed by driving a corresponding engine.

Further, after the update instruction 2_1 is executed, the pre-parsing unit 2011 reads the original instruction 3. The original instruction 3 does not need to be updated, and is directly inputted into the target instruction cache unit 2013, transferred to the instruction parsing unit 202 by the target instruction cache unit 2013. The original instruction 3 can be directly parsed, and then executed by driving a corresponding engine. When header information of the original instruction 3 indicates that this is the last instruction, the entire model ends after executing this instruction.

The target instruction cache unit 2013 is configured to store the original instruction and the update instruction, and input the original instruction and the update instruction into the instruction parsing unit 202. The instruction parsing unit 202 may parse the update instruction or the original instruction, extract parameter information required by a related engine and combination relationship information between the engines, and input the extracted information into the scheduling unit 203. The scheduling unit 203 distributes the parameter information required by the engines to the engines according to the combination relationship, and drives the engines to work, and the engines complete corresponding computation or data migration.

It can be seen from the above that, the instruction processing unit provided in this embodiment of the present disclosure can directly perform access computation on the to-be-executed instructions in the mixed instruction set and a result of a computing engine (the result is stored in the on-chip cache, and the instruction processing unit can directly obtain the result from the on-chip cache), avoiding migrating the data back to the general purpose processor, which is beneficial to improve an online update speed of the original instruction.

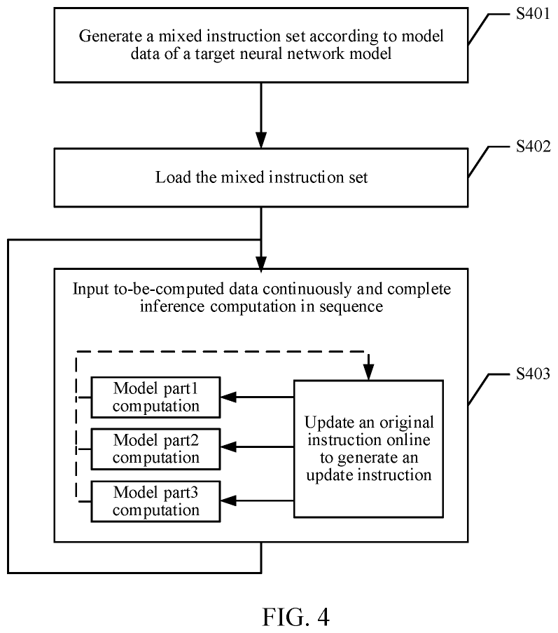

Exemplarily, for a work flow of the instruction processing unit, reference may be made to FIG. 5.

S501. The pre-parsing unit reads the to-be-executed instructions from the mixed instruction set one by one.

S502. Determine whether a read current instruction is control information. If yes, perform step S503, otherwise perform step 507: Input the current instruction into the target instruction cache unit to cache.

S503. The control information execution unit reads target control information (usually the first unexecuted control information in the mixed instruction set) corresponding to the current instruction, and parses the number of control instructions included in the target control information.

S504. Execute the first control instruction in the target control information, and read and execute a next control instruction in the target control information in sequence.

S505. Determine whether the last control instruction in the target control information is executed. If yes, jump to S506, otherwise, return to S505.

S506. Jump to a start point of a new instruction specified by the control information (that is, the update instruction), read the update instruction, and perform S507: Input the update instruction into the target instruction cache unit to cache. Further, the target instruction cache unit inputs the update instruction into the instruction parsing unit in target neural network model computation. It can be seen that, the generation of the update instruction is decoupled from an original instruction set of the target neural network model. The dynamically generated update instruction does not affect a scheduling mode of the original instruction, providing strong flexibility and generality.

It can be understood that, the mixed instruction set in this embodiment of the present disclosure includes the original instruction and the control instruction, but the control instruction is optional. Only a model whose parameters need to be updated online in a computing process needs to include the control instruction. A model whose parameters do not need to be updated online in the computing process, such as a CNN or an RNN, may include the control information. The neural network model computing chip provided in this embodiment of the present disclosure is applicable not only to a scenario of processing some models whose parameters need to be updated online, but also to the widely applied CNN/RNN.

FIG. 2a to FIG. 2c only schematically represent structures of the neural network model computing chip and the instruction processing unit, and do not limit the structures of the neural network model computing chip and the instruction processing unit provided in this embodiment of the present disclosure.

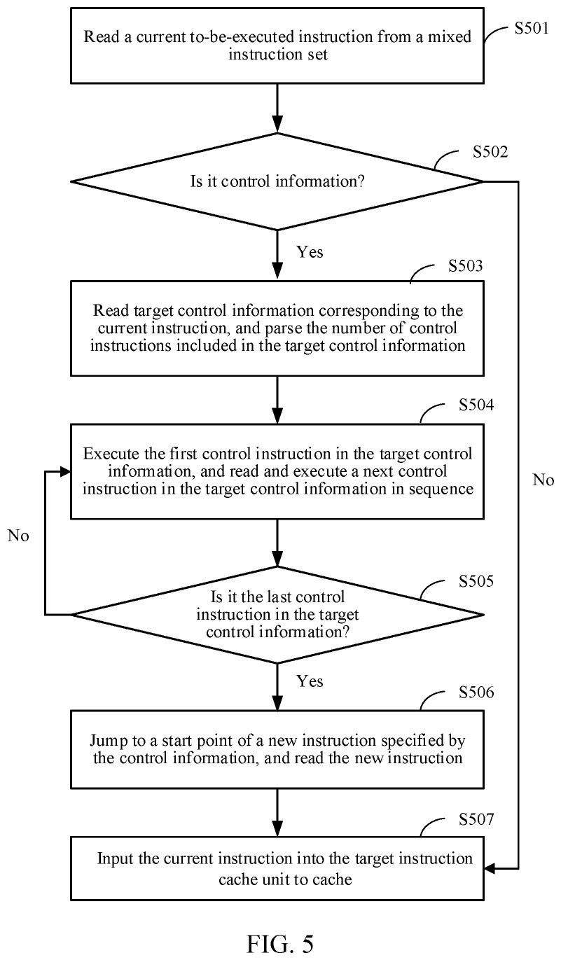

Based on the neural network model computing chip, an embodiment of the present disclosure provides a neural network model computing method shown in FIG. 6. The neural network model computing method may be performed by the neural network model computing chip, and the neural network model computing chip is a chip used for acceleration of intensive computing of a neural network model. The neural network model computing chip may refer to a chip such as a GPU, an FPGA, or an ASIC, and the neural network model computing chip is deployed in a hardware system including a general purpose processor. Referring to FIG. 6, the neural network model computing method includes the following steps S601 to S603.

S601. Obtain a current instruction from a mixed instruction set related to a target neural network model, the mixed instruction set including N (N is an integer greater than 1) instructions to be executed, the mixed instruction set being obtained through pre-compiling based on model data of the target neural network model, and the N instructions including an original instruction and control information used for updating a target original instruction of the target neural network model.

The target neural network model may refer to a model (such as a CNN or an RNN) whose parameters do not need to be updated online in a computing process, or may refer to a model whose parameters need to be updated online in the computing process. For the model whose parameters do not need to be updated online, the corresponding mixed instruction set only includes the original instruction; and for the model whose parameters need to be updated online, the corresponding mixed instruction set includes the original instruction and the control information.

S602. Determine a target instruction based on the current instruction, where when the current instruction is control information, the target instruction is an update instruction obtained after the target original instruction is updated based on the control information. Alternatively, when the current instruction is an original instruction, the target instruction is the current instruction.

The control information includes at least one control instruction and identification information of a to-be-updated instruction, and the at least one control instruction includes any one or more of the following: an operand instruction, a computing instruction, an update instruction, and a jump instruction. The identification information may be used for identifying the to-be-updated instruction, for example, a number of the to-be-updated instruction, or a position of the to-be-updated instruction in the mixed instruction set.

In specific implementation, a mixed instruction set related to the target neural network model may be pre-compiled according to the model data of the target neural network model through a compiler. For a specific compiling manner of the mixed instruction set, reference may be made to the above related description of the instruction generation unit, which is not be repeated herein.

Further, the to-be-executed instructions in the mixed instruction set may be read one by one. During a reading process, a read current instruction may be parsed, to determine a type of the current instruction (the type includes a static instruction and control information). When it is determined that the current instruction is a static instruction, the currently executed instruction may be determined as the target instruction.

Alternatively, when the current instruction is control information, an original instruction matching the identification information is determined from the mixed instruction set as the target original instruction, control instructions in the control information is read and executed one by one, to update the target original instruction, and the updated target original instruction is determined as the target instruction.

The operand instruction includes operand information, the operand information includes any one or more of the following: a specified constant, a storage position and a length of a target operand, and the operand instruction is used for indicating to obtain the target operand or the specified constant. The computing instruction includes any one or more of the following: a comparison computing instruction, an addition and subtraction computing instruction, and a comparison determination computing instruction, the computing instruction is used for indicating to perform target computation, and the target computation includes any one or more of the following: comparison computation, addition and subtraction computation, and comparison determination computation. The update instruction includes a position of an update field and a source of an update value, the update instruction is used for indicating to obtain the update value according to the source, and updating a target field in the target original instruction based on the update value, and the target field is a field corresponding to the position of the update field in the target original instruction. The jump instruction is used for indicating a start address of a to-be-executed instruction next.

A header of the original instruction and a header of the control information both include position information, length information, and type information, the position information is used for indicating a start position of the original instruction or the control information in the mixed instruction set, the length information is used for indicating a length of the original instruction or the control information, the type information is used for indicating a type of the original instruction or the control information, and the type includes an original instruction type and an control information type. A payload of the original instruction includes configuration information of an engine, the configuration information includes any one or more of the following: a type of the engine, an invoking relationship between the engine and parameter information required by the engine to execute the original instruction, and the parameter information includes a computing parameter and/or a position length of an operation object. A payload of the control information includes at least one control instruction.

When a certain original instruction is a very long instruction, that is, one instruction supports combined work of a plurality of engines, configuration information of the original instruction further includes an invoking relationship between the plurality of engines. Exemplarily, for the content included in the two types of instructions, the original instruction and the control information, in the mixed instruction set, reference may be made to Table 1.

TABLE 1

| Header | Position information: a position of this instruction in an entire mixed | |
|---|---|---|
| | instruction set, used for indicating start and end of the instruction | |
| | Length information: a length of this instruction | |
| | Type: an original instruction/control information | |
| Payload | Type 1: an | Type 2: control information (optional, |
| | original | it needs to be included during online |
| | instruction | generation of an instruction) |
| | Length of this instruction | Length of this instruction |
| | Configuration information of | Obtain an operand instruction: a |
| | a computing engine/migration | position, a length, or a specified |
| | engine, including a position | constant of an operand in an |
| | length of an operation object, and | on-chip cache |
| | a parameter required for this | Computing instruction: such as a |
| | computation, such as a size of a | comparison computation or an |
| | convolution kernel, or | addition and subtraction operation |
| | a stride size; | Update instruction: a position of |
| | When a very long instruction | updating an original instruction field, |
| | word is supported, one | and a source of an updated value |
| | instruction supports combined | Jump instruction: the last |
| | work of a plurality of engines, | instruction used for indicating a start |
| | indicating a combination | position of an updated original |
| | relationship | instruction (that is, the update |
| | | instruction described in this solution) |

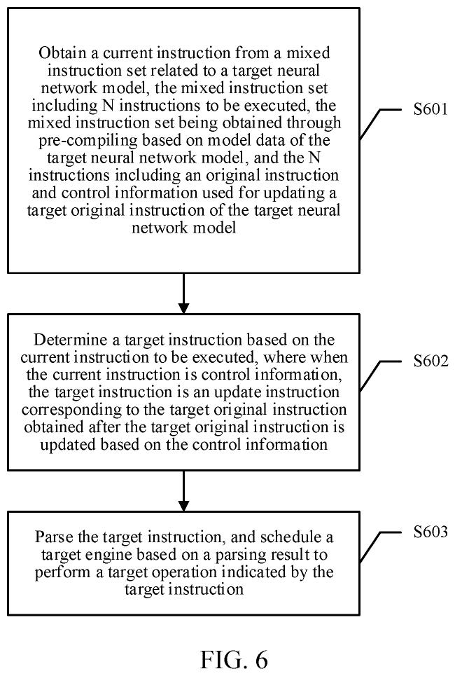

Exemplarily, it is assumed that the mixed instruction set related to the target neural network model shown in FIG. 3 includes an original instruction 1, an original instruction 2, control information 1, an original instruction 3, control information 2, and an original instruction 4 in sequence. The control information 1 includes the following Instruction: performing operation based on the control information according to an engine execution result of the original instruction 2, to generate a target instruction 2_1 online based on the original instruction 2. The control information 2 includes the following instruction: performing operation based on the control information according to an engine execution result of the original instruction 3, to generate a target instruction 4_1 online based on the original instruction 4. In this case, for a flow of updating the target original instruction online based on control information to obtain an update instruction corresponding to the target original instruction, reference may be made to FIG. 7. Specifically, the neural network model computing chip may read the to-be-executed instructions in the mixed instruction set one by one. The original instruction 1 and the original instruction 2 do not need to be updated, the original instruction 1 is directly determined as a target instruction 1, and the original instruction 2 is directly determined as a target instruction 2. The original instruction 1 and the original instruction 2 may be directly parsed, and then executed by driving a corresponding engine. For the control information 1, the engine execution result of the original instruction 2 may be obtained from the on-chip cache based on the indication of the control information 1, and the new instruction 2_1 is generated online based on the original instruction 2 according to the content of the control information (that is, the original instruction 2 is updated to obtain the update instruction 2_1 corresponding to the original instruction 2). The update instruction 2_1 is determined as a target instruction 2_1, and an address of a next instruction may be specified as a start position of the target instruction 2_1. The next instruction is read from the target instruction 2_1, and the target instruction 2_1 may be directly parsed, and then executed by driving a corresponding engine.

Further, after the update instruction 2_1 is executed, the original instruction 3 is read. The original instruction 3 does not need to be updated, and is directly determined as a target instruction 3. The target instruction 3 can be directly parsed, and then executed by driving a corresponding engine. After the target instruction 3 is executed, the control information 2 is read, and an engine execution result of the target instruction 3 is read from the on-chip cache based on the indication of the control information 2. The original instruction 4 is updated as a target instruction 4_1 according to the content of the control information, and an address of a next instruction is specified as a start position of the target instruction 4_1. The next instruction is read from the target instruction 4_1, and the target instruction 4_1 may be directly parsed, and then executed by driving a corresponding engine. When header information of the target instruction 4_1 indicates that this is the last instruction, the entire model ends after executing this instruction.

In another example, in combination with the example corresponding to FIG. 7, it is assumed that, more specific information represented by the control information 1 is: detect content in an A address of the on-chip cache, if it is equal to B, re-execute the instruction 2, and update a C field in the instruction 2 to D; otherwise, execute the next instruction 3. In this case, a processing flow of updating an instruction online based on the control information 1 is:

1. Read and execute an operand obtaining instruction in the control information 1, determine content in the A address as a target operand, and read the content in the A address into a processing unit.

2. Read and execute a computing instruction in the control information 1, perform comparison computation, and compare the content in the A address with B.

3. When a result of the comparison computation is that the content in the A address is consistent with B, read and execute an update instruction in the control information 1, and update the C field in the instruction 2 to D, thereby obtaining an update instruction 2_1. Then through a jump instruction in the control information 1, specify an address of a next to-be-executed instruction as a start address of the update instruction 2_1.

4. When a result of the comparison computation is that the content in the A address is not consistent with B, skip the update operation. Then through the jump instruction in the control information 1, specify an address of a next to-be-executed instruction as a start address of the original instruction 3.

It can be seen from the above that, the control information part in this embodiment of the present disclosure is designed towards an AI application, and only operations of operand obtaining, computation, updating, and jumping instruction are needed to complete the online update of an instruction. The implementation complexity is low, the chip area consumption is small, and the interaction with the neural network model computing chip is completed at a lower cost.

S603. Parse the target instruction, schedule a target engine based on a parsing result to perform a target operation indicated by the target instruction, the target operation including a computing operation or a data migration operation, and the target engine being any one of a plurality of pre-configured engines.

The plurality of engines may include a computing engine and a data migration engine. Specifically, for different types of computations, the computing engine may also include a plurality of types of computing engines, such as a computing engine for convolution, and a computing engine for pooling. During the target neural network model computation, corresponding data is migrated in and out. Correspondingly, the data migration engine may also include a data migration engine for migrating out data and a data migration engine for migrating in data. The data migrating in and out herein can be understood as migrating data from the storage medium into the on-chip cache of the neural network model computing chip, and migrating the data from the on-chip cache to the storage medium. The computing operation may match the type of the computing engine, for example, convolution computing or pooling computing. The data migration operation may be, for example, a data migrate-out operation, or a data migrate-in operation.

When the target instruction is a very long instruction, the instruction may support combined work of a plurality of engines. In this case, configuration information of the target instruction further includes an invoking relationship between the plurality of engines. In specific implementation, assuming that the target instruction is a very long instruction, the target instruction corresponds to a plurality of to-be-invoked engines, and a parsing result obtained by parsing the target instruction includes configuration information of the to-be-invoked engines, a specific implementation of scheduling a target engine matching the target instruction based on the parsing result, to perform a target operation indicated by the target instruction may be as follows: obtaining types of the to-be-invoked target engines, parameter information required to execute the target instruction, and an invoking relationship between the to-be-invoked engines from the configuration information of the to-be-invoked engines, and determine an engine matching the types of the to-be-invoked engines among the plurality of pre-configured engines as the target engine. Further, the parameter information required to execute the target instruction is distributed to the target engines according to the invoking relationship between the to-be-invoked engines, and the target engines are invoked to perform the target operation indicated by the target instruction.

The types of the to-be-invoked engines may include different types of computing engines (such as a computing engine for convolution and a computing engine for pooling), or may include a data migration engine for migrating out data and a data migration engine for migrating in data. The parameter information required to execute the target instruction distributed to the target engines may be, for example, a storage address of to-be-computed data of the computing engine on the on-chip cache, and a storage address of to-be-migrated data of the migration engine on the on-chip cache or a storage medium.

Exemplarily, it is assumed that the to-be-invoked engines corresponding to the target instruction include a to-be-invoked engine 1 and a to-be-invoked engine 2, a type of the to-be-invoked engine 1 is a data migration engine for migrating in data, a type of the to-be-invoked engine 2 is a convolution computing engine, and an invoking relationship between the to-be-invoked engine 1 and the to-be-invoked engine 2 is: the to-be-invoked engine 1→the to-be-invoked engine 2. In this case, the data migration engine used for migrating in data in the plurality of pre-configured engines is determined as a target engine 1 matching the type of the to-be-invoked engine 1, and the convolution computing engine in the plurality of pre-configured engines is determined as a target engine 2 matching the type of the to-be-invoked engine 2. According to the invoking relationship between the to-be-invoked engines the parameter information required to execute the target instruction is first distributed to the target engine 1 in sequence, and the target engine 1 is invoked to perform the data migration operation indicated by the target instruction. Further, after the data migration operation is completed, the parameter information required to execute the target instruction is first distributed to the target engine 2, and the target engine 2 is invoked to perform convolution computing indicated by the target instruction.

It can be understood that, in this embodiment of the present disclosure, all to-be-executed instructions in the mixed instruction set may be read and executed in the manner of S601-S603. After all to-be-executed instructions in the mixed instruction set are executed, corresponding entire model computation is completed. The final computing result of the target neural network model may be handed over to a general purpose processor side, and the general purpose processor side completes other required post-processing work (such as image information annotation, and layer processing).

In this embodiment of the present disclosure, the neural network model computing chip may obtain a current instruction from a mixed instruction set related to a target neural network model. When the current instruction is control information, control instructions in the control information are obtained and executed one by one, and an update instruction corresponding to an obtained target original instruction is determined as a target instruction. Further, the target instruction is parsed, and a target engine is scheduled based on a parsing result to perform a target operation indicated by the target instruction. The instruction can be updated online inside the neural network model computing chip, to reduce interactions with other devices (such as a general purpose processor), and efficiently implement computation of a model whose parameters need to be updated online.

An embodiment of the present disclosure further provides a computer storage medium, storing program instructions, the program instructions, when executed, being used for performing the corresponding method described in the foregoing embodiments.

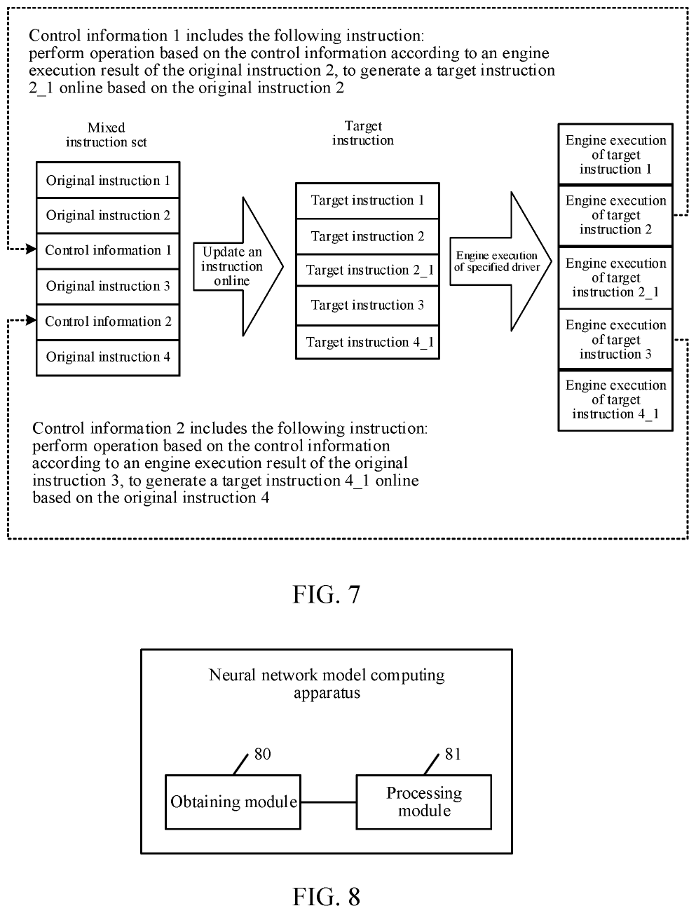

FIG. 8 is a schematic structural diagram of a neural network model computing apparatus according to an embodiment of the present disclosure. The neural network model computing apparatus in this embodiment of the present disclosure may be arranged in the neural network model computing chip, and the apparatus includes:

an obtaining module 80, configured to obtain a current instruction from a mixed instruction set related to a target neural network model, the mixed instruction set including N to-be-executed instructions, the mixed instruction set being obtained through pre-compiling based on model data of the target neural network model, the N to-be-executed instructions including an original instruction and control information used for updating a target original instruction of the target neural network model, and N being an integer greater than 1; and

a processing module 81, configured to determine a target instruction based on the current instruction, where when the current instruction is control information, the target instruction is an update instruction corresponding to the target original instruction obtained after the target original instruction is updated based on the control information.

The processing module 81 is further configured to parse the target instruction, and schedule a target engine based on a parsing result to perform a target operation indicated by the target instruction, the target operation including a computing operation or a data migration operation, and the target engine being any one of a plurality of pre-configured engines.

In some embodiments, the processing module 81 is further configured to update, when the current instruction is control information, the target original instruction based on the control information to obtain an update instruction corresponding to the target original instruction, and determine the update instruction as the target instruction; and when the current instruction is an original instruction, determine the current instruction as the target instruction.

In some embodiments, the control information includes at least one control instruction and identification information of a to-be-updated instruction, and the at least one control instruction includes any one or more of the following: an operand instruction, a computing instruction, an update instruction, and a jump instruction. The processing module 81 is specifically configured to determine an original instruction matching the identification information from the mixed instruction set as the target original instruction, read and execute control instructions in the control information one by one, to update the target original instruction, and determine the updated target original instruction as the target instruction.

In some embodiments, the operand instruction includes operand information, the operand information includes any one or more of the following: a specified constant, a storage position and a length of target operand, and the operand instruction is used for indicating to obtain the target operand or the specified constant; the computing instruction includes any one or more of the following: a comparison computing instruction, an addition and subtraction computing instruction, and a comparison determination computing instruction, the computing instruction is used for indicating to perform target computation, and the target computation includes any one or more of the following: comparison computation, addition and subtraction computation, and comparison determination computation. The update instruction includes a position of an update field and a source of an update value, the update instruction is used for indicating to obtain the update value according to the source, and updating a target field in the target original instruction based on the update value, and the target field is a field corresponding to the position of the update field in the target original instruction. The jump instruction is used for indicating a start address of a to-be-executed instruction next.

In some embodiments, a header of the original instruction and a header of the control information both include position information, length information, and type information, the position information is used for indicating a start position of the original instruction or the control information in the mixed instruction, the length information is used for indicating a length of the original instruction or the control information, the type information is used for indicating a type of the original instruction or the control information, and the type includes an original instruction type and an control information type. A payload of the original instruction includes configuration information of an engine, the configuration information includes any one or more of the following: a type of the engine, an invoking relationship between the engine and parameter information required by the engine to execute the original instruction, and the parameter information includes a computing parameter and/or a position length of an operation object. A payload of the control information includes at least one control instruction.

In some embodiments, the target instruction corresponds to a plurality of to-be-invoked engines, and the parsing result includes configuration information of the to-be-invoked engines. The processing module 81 is further specifically configured to obtain types of the to-be-invoked target engines, parameter information required to execute the target instruction, and an invoking relationship between the to-be-invoked engines from the configuration information of the to-be-invoked engines; and determine an engine matching the types of the to-be-invoked engines among the plurality of pre-configured engines as the target engine; distribute the parameter information required to execute the target instruction to the target engine according to the invoking relationship between the to-be-invoked engines, and invoke the target engines to perform the target operation indicated by the target instruction.

In this embodiment of the present disclosure, for specific implementations of the foregoing modules, reference may be made to the description of related content in the embodiments corresponding to the foregoing accompanying drawings.

In this embodiment of the present disclosure, the neural network model computing apparatus may obtain a current instruction from a mixed instruction set related to a target neural network model. When the current instruction is control information, control instructions in the control information are obtained and executed one by one, and an update instruction corresponding to an obtained target original instruction is determined as a target instruction. Further, the target instruction is parsed, and a target engine is scheduled based on a parsing result to perform a target operation indicated by the target instruction. The instruction can be updated online internally, to reduce interactions with other devices (such as a general purpose processor), and efficiently implement computation of a model whose parameters need to be updated online.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

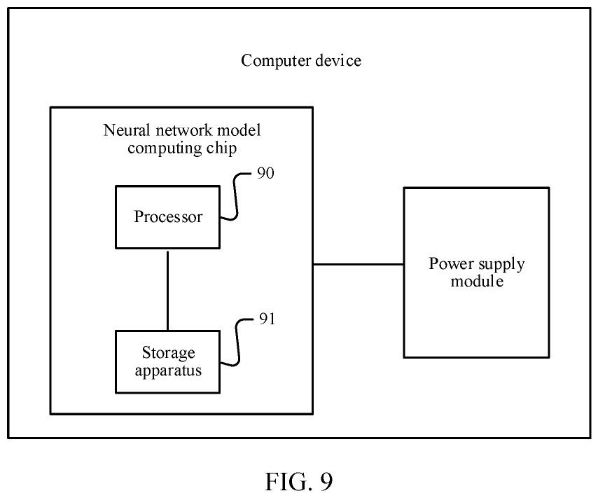

FIG. 9 is a schematic structural diagram of a computer device according to an embodiment of the present disclosure. The computer device in this embodiment of the present disclosure includes structures such as a power supply module, a neural network model computing chip is installed on the computer device, and the neural network model computing chip includes a processor 90 and a storage apparatus 91. The processor 90 and the storage apparatus 91 may exchange data, and the processor 90 implements a corresponding neural network model computing function.

The storage apparatus 91 may include a volatile memory, for example, a random access memory (RAM). The storage apparatus 91 may include a non-volatile memory, for example, a flash memory, or a solid-state drive (SSD). The storage apparatus 91 may further include a combination of the foregoing types of memories.

The processor 90 may be a dedicated processor used for acceleration of intensive computing of a neural network model, such as a GPU, an FPGA, or an ASIC.

In some embodiments, the storage apparatus 91 is configured to store program instructions. The processor 90 may invoke the program instructions to implement the foregoing methods related to the embodiments of the present disclosure.

The computer device in this embodiment of the present disclosure may obtain a current instruction from a mixed instruction set related to a target neural network model through a neural network model computing chip. When the current instruction is control information, control instructions in the control information are obtained and executed one by one, and an update instruction corresponding to an obtained target original instruction is determined as a target instruction. Further, the target instruction is parsed, and a target engine is scheduled based on a parsing result to perform a target operation indicated by the target instruction. The instruction can be updated online internally, to reduce interactions with other devices (such as a general purpose processor), and efficiently implement computation of a model whose parameters need to be updated online.

A person of ordinary skill in the art may understand that all or some of the processes of the methods in the foregoing embodiments may be implemented by a computer program instructing relevant hardware. The program may be stored in a computer-readable storage medium. During the execution of the program, processes of the foregoing method embodiments may be included. The foregoing storage medium may be a magnetic disc, an optical disc, a read-only memory (ROM), a RAM, or the like.

The foregoing descriptions are merely some embodiments of the present disclosure, and are not intended to limit the scope of the present disclosure. A person of ordinary skill in the art may understand and implement all or some procedures of the foregoing embodiments, and equivalent modifications made according to the claims of the present disclosure shall still fall within the scope of the present invention.

What is claimed is:

1. A neural network model computing chip, comprising: an instruction processing unit, an instruction parsing unit, a scheduling unit, and an execution unit for data migration and computation, the execution unit comprising a plurality of pre-configured engines, wherein
the instruction processing unit is configured to provide a target instruction to the instruction parsing unit, the target instruction comprising at least one of an original instruction or an update instruction of a target neural network model; the update instruction being obtained after a target original instruction is updated based on control information of the target neural network model, and the target original instruction being an original instruction matching the control information in original instructions of the target neural network model;
the instruction parsing unit is configured to parse the target instruction to obtain a parsing result, and input the parsing result into the scheduling unit; and
the scheduling unit is configured to schedule a target engine based on the parsing result to perform a target operation indicated by the target instruction, the target operation comprising a computing operation or a data migration operation, and the target engine being one of the plurality of pre-configured engines of the execution unit.

2. The chip according to claim 1, further comprising: an instruction generation unit, an instruction cache unit, and an on-chip cache, wherein:
the instruction generation unit is configured to compile a mixed instruction set of the target neural network model through a compiler according to model data of the target neural network model, the mixed instruction set comprises N instructions to be executed, the N instructions comprise the original instruction and the control information used for updating the target original instruction, and N is an integer greater than 1;
the instruction cache unit is configured to store the mixed instruction set; and
the on-chip cache is configured to store target data required for computation of the target neural network model.

3. The chip according to claim 2, wherein the target data comprises at least one of: data to be computed and preprocessed by a general purpose processor of a hardware system, the data to be computed comprises at least one of image data, voice data, or text data; and an intermediate computing result and a final computing result of the target neural network model computation.

4. The chip according to claim 2, wherein the instruction processing unit comprises: a pre-parsing unit, a control information execution unit, and a target instruction cache unit, wherein:
the pre-parsing unit is configured to read the N instructions one by one from the mixed instruction set stored in the instruction cache unit, input the original instruction in the mixed instruction set into the target instruction cache unit, and input the control information in the mixed instruction set into the control information execution unit;
the control information execution unit is configured to obtain an update instruction after updating the target original instruction based on the control information, and input the update instruction into the target instruction cache unit; and
the target instruction cache unit is configured to store the original instruction and the update instruction, and input the original instruction and the update instruction into the instruction parsing unit.

5. The chip according to claim 4, wherein the control information comprises at least one control instruction and identification information of the target original instruction, and the at least one control instruction comprises at least one of: an operand instruction, a computing instruction, an update instruction, or a jump instruction; and
the control information execution unit is further configured to:
determine an original instruction matching the identification information from the mixed instruction set as the target original instruction;
read and execute control instructions in the control information one by one, to update the target original instruction; and
determine the updated target original instruction as the target instruction.

6. The chip according to claim 5, wherein the operand instruction comprises operand information, the operand information comprises at least one of: a specified constant, a storage position of a target operand, or a length of the target operand, and the operand instruction is used for indicating to obtain the target operand or the specified constant;
the computing instruction comprises at least one of: a comparison computation instruction, an addition and subtraction computing instruction, or a comparison determination computing instruction, the computing instruction is used for indicating to perform target computation, and the target computation comprises at least one of: comparison computation, addition and subtraction computation, or comparison determination computation;
the update instruction comprises a position of an update field and a source of an update value, the update instruction is used for indicating to obtain the update value according to the source, and updating a target field in the target original instruction based on the update value, and the target field is a field corresponding to the position of the update field in the target original instruction; and
the jump instruction is used for indicating a start address of a to-be-executed instruction next.

7. The chip according to claim 2, wherein a header of the original instruction and a header of the control information both comprise position information, length information, and type information, the position information is used for indicating a start position of the original instruction or the control information in the mixed instruction set, the length information is used for indicating a length of the original instruction or the control information, the type information is used for indicating a type of the original instruction or the control information, and the type comprises an original instruction type and an control information type;
a payload of the original instruction comprises configuration information of an engine, the configuration information comprises at least one of: a type of the engine, an invoking relationship between the pre-configured engines, or parameter information required by the engine to execute the original instruction, and the parameter information comprises a computing parameter and/or a position length of an operation object; and
a payload of the control information comprises at least one control instruction.

8. The chip according to claim 7, wherein the target instruction corresponds to a plurality of target engines to be invoked, the parsing result comprises configuration information of the target engines, and the scheduling unit is further configured to:
obtain types of the target engines, parameter information required to execute the target instruction, and an invoking relationship between the engines from the parsing result;
determine an engine matching one of the types of the target engines in the parsing result among the plurality of pre-configured engines as one of the target engines; and
distribute the parameter information required to execute the target instruction to the target engines according to the invoking relationship between the target engines in the parsing result, and invoke the target engines to execute the target operation indicated by the target instruction.

9. A neural network model computing method, applied to a neural network model computing chip, the method comprising:
obtaining a current instruction from a mixed instruction set related to a target neural network model, the mixed instruction set comprising N instructions to be executed, the mixed instruction set being obtained through pre-compiling based on model data of the target neural network model, the N instructions comprising an original instruction and control information used for updating a target original instruction of the target neural network model, and N being an integer greater than 1;
determining a target instruction based on the current instruction, wherein when the current instruction is control information, the target instruction is an update instruction obtained after the target original instruction is updated based on the control information; and
parsing the target instruction to obtain a parsing result, and scheduling a target engine based on the parsing result to perform a target operation indicated by the target instruction, the target operation comprising a computing operation or a data migration operation, and the target engine being one of a plurality of pre-configured engines in the neural network model computing chip.

10. The method according to claim 9, wherein the determining a target instruction based on the current instruction comprises:
updating, when the current instruction is control information, the target original instruction to obtain an update instruction corresponding to the target original instruction based on the control information; and determining the update instruction as the target instruction; and
determining the current instruction as the target instruction when the current instruction is an original instruction.

11. The method according to claim 10, wherein the control information comprises at least one control instruction and identification information of the target original instruction, and the at least one control instruction comprises at least one of: an operand instruction, a computing instruction, an update instruction, or a jump instruction; and
the updating the target original instruction to obtain an update instruction corresponding to the target original instruction based on the control information comprises:
determining an original instruction matching the identification information from the mixed instruction set as the target original instruction;
reading and executing control instructions in the control information one by one, to update the target original instruction; and
determining the updated target original instruction as the target instruction.

12. The method according to claim 11, wherein the operand instruction comprises operand information, the operand information comprises at least one of: a specified constant, a storage position of a target operand, or a length of the target operand, and the operand instruction is used for indicating to obtain the target operand or the specified constant;
the computing instruction comprises at least one of: a comparison computation instruction, an addition and subtraction computing instruction, or a comparison determination computing instruction, the computing instruction is used for indicating to perform target computation, and the target computation comprises at least one of: comparison computation, addition and subtraction computation, or comparison determination computation;
the update instruction comprises a position of an update field and a source of an update value, the update instruction is used for indicating to obtain the update value according to the source, and updating a target field in the target original instruction based on the update value, and the target field is a field corresponding to the position of the update field in the target original instruction; and
the jump instruction is used for indicating a start address of a to-be-executed instruction next.

13. The method according to claim 9, wherein a header of the original instruction and a header of the control information both comprise position information, length information, and type information, the position information is used for indicating a start position of the original instruction or the control information in the mixed instruction set, the length information is used for indicating a length of the original instruction or the control information, the type information is used for indicating a type of the original instruction or the control information, and the type comprises an original instruction type and an control information type;
a payload of the original instruction comprises configuration information of an engine, the configuration information comprises at least one of: a type of the engine, an invoking relationship between the pre-configured engines, or parameter information required by the engine to execute the original instruction, and the parameter information comprises a computing parameter and/or a position length of an operation object; and
a payload of the control information comprises at least one control instruction.

14. The method according to claim 13, wherein the target instruction corresponds to a plurality of target engines to be invoked, the parsing result comprises configuration information of the target engines, and the scheduling a target engine matching the target instruction based on a parsing result to perform a target operation indicated by the target instruction comprises:
obtaining types of the target engines, parameter information required to execute the target instruction, and an invoking relationship between the engines from the parsing result;
determining an engine matching one of the types of the target engines in the parsing result among the plurality of pre-configured engines as one of the target engines; and
distributing the parameter information required to execute the target instruction to the target engines according to the invoking relationship between the target engines in the parsing result, and invoking the target engines to execute the target operation indicated by the target instruction.

15. A computer device, installed with a neural network model computing chip, the neural network model computing chip comprising a processor and a storage apparatus, the processor and the storage apparatus being connected to each other, the storage apparatus being configured to store a computer program, and the processor being configured to execute the computer program, to perform:
obtaining a current instruction from a mixed instruction set related to a target neural network model, the mixed instruction set comprising N instructions to be executed, the mixed instruction set being obtained through pre-compiling based on model data of the target neural network model, the N instructions comprising an original instruction and control information used for updating a target original instruction of the target neural network model, and N being an integer greater than 1;
determining a target instruction based on the current instruction, wherein when the current instruction is control information, the target instruction is an update instruction obtained after the target original instruction is updated based on the control information; and
parsing the target instruction to obtain a parsing result, and scheduling a target engine based on the parsing result to perform a target operation indicated by the target instruction, the target operation comprising a computing operation or a data migration operation, and the target engine being one of a plurality of pre-configured engines in the neural network model computing chip.

16. The device according to claim 15, wherein the determining a target instruction based on the current instruction comprises:
updating, when the current instruction is control information, the target original instruction to obtain an update instruction corresponding to the target original instruction based on the control information; and determining the update instruction as the target instruction; and
determining the current instruction as the target instruction when the current instruction is an original instruction.

17. The device according to claim 16, wherein the control information comprises at least one control instruction and identification information of the target original instruction, and the at least one control instruction comprises at least one of: an operand instruction, a computing instruction, an update instruction, or a jump instruction; and
the updating the target original instruction to obtain an update instruction corresponding to the target original instruction based on the control information comprises:
determining an original instruction matching the identification information from the mixed instruction set as the target original instruction;
reading and executing control instructions in the control information one by one, to update the target original instruction; and
determining the updated target original instruction as the target instruction.

18. The device according to claim 17, wherein the operand instruction comprises operand information, the operand information comprises at least one of: a specified constant, a storage position of a target operand, or a length of the target operand, and the operand instruction is used for indicating to obtain the target operand or the specified constant;
the computing instruction comprises at least one of: a comparison computation instruction, an addition and subtraction computing instruction, or a comparison determination computing instruction, the computing instruction is used for indicating to perform target computation, and the target computation comprises at least one of: comparison computation, addition and subtraction computation, or comparison determination computation;
the update instruction comprises a position of an update field and a source of an update value, the update instruction is used for indicating to obtain the update value according to the source, and updating a target field in the target original instruction based on the update value, and the target field is a field corresponding to the position of the update field in the target original instruction; and
the jump instruction is used for indicating a start address of a to-be-executed instruction next.

19. The device according to claim 15, wherein a header of the original instruction and a header of the control information both comprise position information, length information, and type information, the position information is used for indicating a start position of the original instruction or the control information in the mixed instruction set, the length information is used for indicating a length of the original instruction or the control information, the type information is used for indicating a type of the original instruction or the control information, and the type comprises an original instruction type and an control information type;
a payload of the original instruction comprises configuration information of an engine, the configuration information comprises at least one of: a type of the engine, an invoking relationship between the pre-configured engines, or parameter information required by the engine to execute the original instruction, and the parameter information comprises a computing parameter and/or a position length of an operation object; and
a payload of the control information comprises at least one control instruction.

20. The device according to claim 19, wherein the target instruction corresponds to a plurality of target engines to be invoked, the parsing result comprises configuration information of the target engines, and the scheduling a target engine matching the target instruction based on a parsing result to perform a target operation indicated by the target instruction comprises:
obtaining types of the target engines, parameter information required to execute the target instruction, and an invoking relationship between the engines from the parsing result;
determining an engine matching one of the types of the target engines in the parsing result among the plurality of pre-configured engines as one of the target engines; and
distributing the parameter information required to execute the target instruction to the target engines according to the invoking relationship between the target engines in the parsing result, and invoking the target engines to execute the target operation indicated by the target instruction.
